(19) United States
(12) Patent Application Publication
(10) Pub. No.: US 2020/0040719 A1
(43) Pub. Date: Feb. 6, 2020

(54) Machine-Learning Based Drilling Models for A New Well

(71) Applicant: Schlumberger Technology Corporation, Sugar Land, TX (US)

(72) Inventors: Hiren Maniar, Houston, TX (US); Sunil Garg, Katy, TX (US); Juan Fernando Corrales Estrada, Houston, TX (US); Henry Martinez, Houston, TX (US)

(21) Appl. No.: 16/339,706

(22) PCT Filed: Oct. 5, 2016
(86) PCT No.: PCT/US2016/055409

§ 371 Date: Apr. 4, 2019

(51) Int. Cl. E21B 44/00; G06N 20/00; E21B 41/00

(52) U.S. Cl. CPC E21B 44/00; E21B 45/00; E21B 41/00; G06N 20/00

(57) ABSTRACT

The disclosure relates to a method for performing a drilling operation in a subterranean formation of a field. The method includes obtaining, prior to the drilling operation, a target well data set specifying a target well to be drilled, selecting, from a set of existing wells, a number of analog wells that satisfy a pre-determined similarity criterion with respect to the target well, generating, from a number of analog well data sets of the analog wells, a training data set for the target well, where the training data set includes a rate-of-penetration (ROP) profile for each analog well, generating, using a machine-learning algorithm and based on the training data set, a drilling model that predicts the ROP profile of the target well, and performing, based on the drilling model, modeling of the drilling operation to generate a predicted ROP profile of the target well.

### BACKGROUND

Drilling a well into a subterranean formation is a complex activity due to dynamic interactions between several underlying factors influencing the drilling activity. For example, the underlying factors may include controllable inputs to the drilling system and resultant responses from the drilling system. Modeling the drilling activity attempts to mathematically describe the dynamic interactions between the underlying factors. Based on the models, activities such as well-planning, rate of penetration (ROP) prediction, and event detection may be performed.

### SUMMARY

In general, in one aspect, embodiments provide a method for performing a drilling operation in a subterranean formation of a field. The method includes obtaining, prior to the drilling operation, a target well data set specifying a target well to be drilled, selecting, from a plurality of existing wells, a plurality of analog wells that satisfy a pre-determined similarity criterion with respect to the target well, generating, from a plurality of analog well data sets of the plurality of analog wells, a training data set for the target well, wherein the training data set comprises a rate-of-penetration (ROP) profile for each of the plurality of analog wells, generating, using a machine-learning algorithm and based on the training data set, a drilling model that predicts the ROP profile of the target well, and performing, based on the drilling model, modeling of the drilling operation to generate a predicted ROP profile of the target well.

Other aspects will be apparent from the following description and the appended claims.

### BRIEF DESCRIPTION OF DRAWINGS

The appended drawings illustrate several embodiments of machine-learning based drilling models for a new well. The drawings are not intended to limit the scope of this disclosure. As understood by one of ordinary skill in the art, equally effective embodiments that are not illustrated may be within the scope of this disclosure.

FIG. 1.1 is a schematic view, partially in cross-section, of a field in which one or more embodiments of machine-learning based drilling models for a new well may be implemented.

FIG. 1.2 shows a schematic diagram of a system in accordance with one or more embodiments.

FIG. 2 shows a flowchart in accordance with one or more embodiments.

FIGS. 3.1 and 3.2 show examples in accordance with one or more embodiments.

FIGS. 4.1 and 4.2 show systems in accordance with one or more embodiments.

### DETAILED DESCRIPTION

Specific embodiments will now be described in detail with reference to the accompanying figures. Like elements in the various figures are denoted by like reference numerals for consistency.

In the following detailed description of embodiments, numerous specific details are set forth in order to provide a more thorough understanding. However, it will be apparent to one of ordinary skill in the art that one or more embodiments may be practiced without these specific details. In other instances, well-known features have not been described in detail to avoid unnecessarily complicating the description.

In general, embodiments provide a method and a system for performing a drilling operation in a subterranean formation of a field. In one or more embodiments, the method includes selecting analog wells based on satisfying a similarity criterion with respect to a target well. The analog wells are used to generate a drilling model and predict a rate of penetration (ROP) profile for the target well.

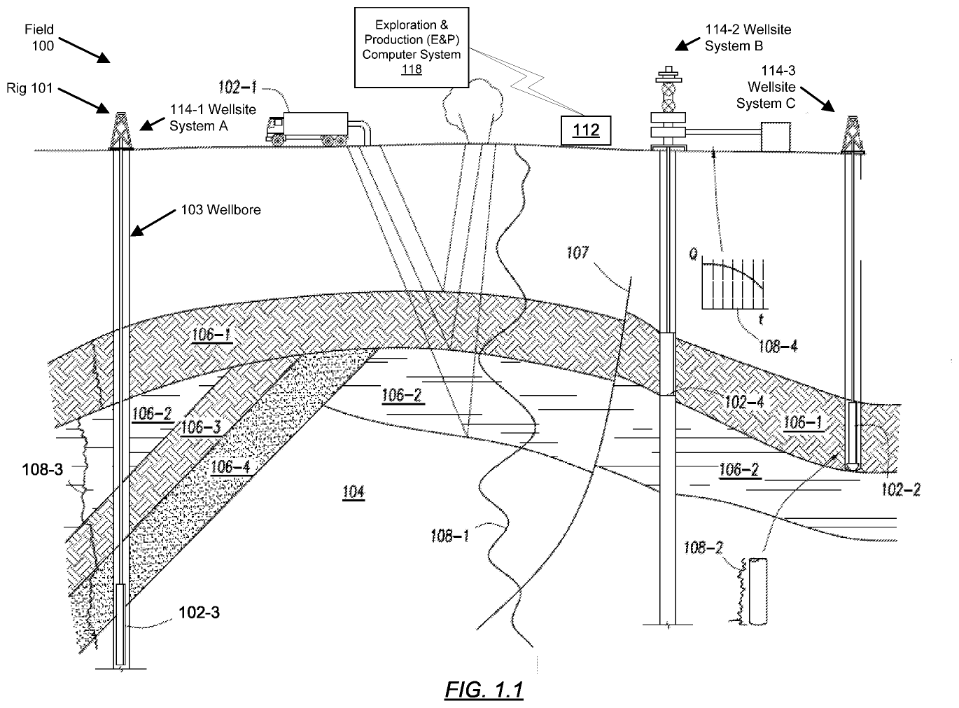

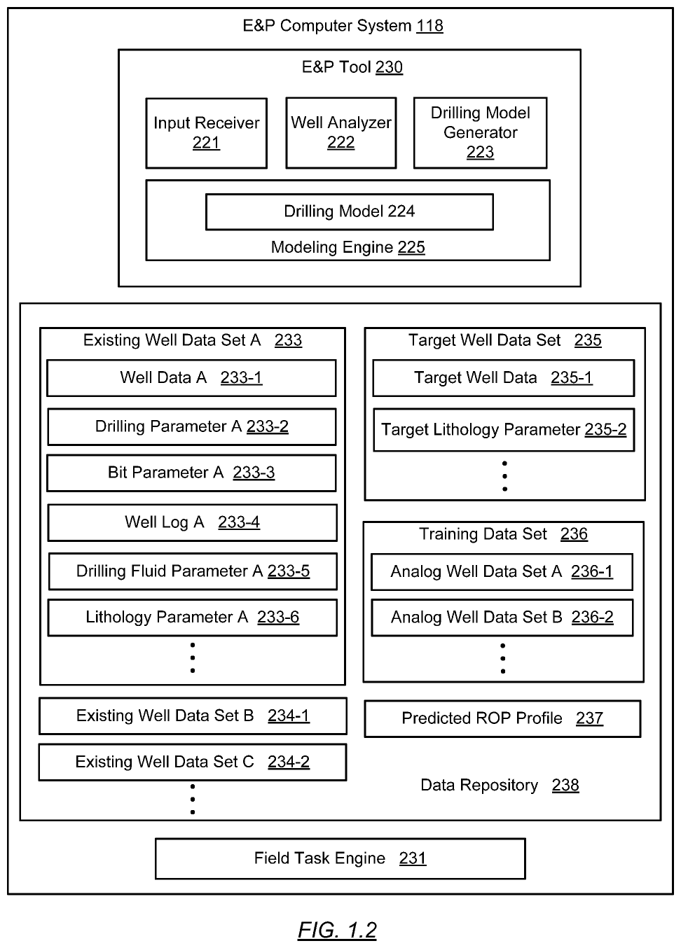

FIG. 1.1 depicts a schematic view, partially in cross section, of a field (100) in which one or more embodiments of machine-learning based drilling models for a new well may be implemented. In one or more embodiments, one or more of the modules and elements shown in FIG. 1.1 may be omitted, repeated, and/or substituted. Accordingly, embodiments of machine-learning based drilling models for a new well should not be considered limited to the specific arrangements of modules shown in FIG. 1.1.

As shown in FIG. 1.1, the field (100) includes the subterranean formation (104), data acquisition tools (102-1), (102-2), (102-3), and (102-4), wellsite system A (114-1), wellsite system B (114-2), wellsite system C (114-3), a surface unit (112), and an exploration and production (E&P) computer system (118). The geology of the subterranean formation (104) includes several formations and structures, such as a sandstone layer (106-1), a limestone layer (106-2), a shale layer (106-3), a sand layer (106-4), and a faulted zone (107). In particular, these geological structures form at least one reservoir containing fluids, such as hydrocarbon.

In one or more embodiments, data acquisition tools (102-1), (102-2), (102-3), and (102-4) are positioned at various locations along the field (100) for collecting data of the subterranean formation (104). Such data collection is referred to as survey and logging operations. In particular, the data acquisition tools are adapted to measure the subterranean formation (104) and detect the characteristics and conditions of the geological structures of the subterranean formation (104). For example, data plots (108-1), (108-2), (108-3), and (108-4) are depicted along the field (100) to demonstrate the data generated by the data acquisition tools. Specifically, the static data plot (108-1) is a seismic two-way response time. Static data plot (108-2) is core sample data measured from a core sample of the subterranean formation (104). Static data plot (108-3) is a logging trace, which is referred to as a well log. Production decline curve or graph (108-4) is a dynamic data plot of the fluid flow rate over time. Other data may also be collected, such as historical data, analyst user inputs, economic information, and/or other measurement data and other parameters of interest.

As also shown in FIG. 1.1, each of the wellsite system A (114-1), wellsite system B (114-2), and wellsite system C (114-3) is associated with a rig, a wellbore, and other wellsite equipment configured to perform wellbore operations, such as logging, drilling, fracturing, production, or other applicable operations. For example, the wellsite system A (114-1) is associated with a rig (101), a wellbore (103), and drilling equipment to perform drilling operations. Similarly, the wellsite system B (114-2) and wellsite system C (114-3) are associated with respective rigs, wellbores, and other wellsite equipment, such as production equipment to perform production operations and logging equipment to perform logging operations. Generally, survey and logging operations and wellbore operations are referred to as field operations of the field (100). In addition, data acquisition tools and wellsite equipment are referred to as field operation equipment. The field operations are performed as directed by a surface unit (112). For example, the field operation equipment may be controlled by a field operation control signal that is sent from the surface unit (112).

In one or more embodiments, the surface unit (112) is operatively coupled to the data acquisition tools (102-1), (102-2), (102-3), (102-4), and/or the wellsite systems. In particular, the surface unit (112) is configured to send commands to the data acquisition tools (102-1), (102-2), (102-3), (102-4), and/or the wellsite systems and to receive data therefrom. In one or more embodiments, the surface unit (112) may be located at the wellsite system A (114-1), wellsite system B (114-2), wellsite system C (114-3), and/or remote locations. The surface unit (112) may be provided with computer facilities for receiving, storing, processing, and/or analyzing data from the data acquisition tools (102-1), (102-2), (102-3), (102-4), the wellsite system A (114-1), wellsite system B (114-2), wellsite system C (114-3), and/or other parts of the field (100). The computer facilities may include an E&P computer system (118) having one or more portions located in the surface unit (112) and/or located remotely, such as in a computing cloud via the Internet. The surface unit (112) may also be provided with or have functionality for actuating mechanisms at the field (100). The surface unit (112) may then send command signals to the field (100) in response to data received, stored, processed, and/or analyzed to, for example, control and/or optimize the various field operations described above.

In one or more embodiments, the surface unit (112) is communicatively coupled to the E&P computer system (118). In one or more embodiments, the data received by the surface unit (112) may be sent to the E&P computer system (118) for further analysis. Generally, the E&P computer system (118) is configured to analyze, model, control, optimize, or perform management tasks of the aforementioned field operations based on the data provided from the surface unit (112). In one or more embodiments, the E&P computer system (118) is provided with functionality for manipulating and analyzing the data. Such functionality may include performing simulations, planning, and optimizing drilling and/or production operations of the wellsite system A (114-1), wellsite system B (114-2), and/or wellsite system C (114-3). In one or more embodiments, the result generated by the E&P computer system (118) may be displayed to an analyst user via a two dimensional (2D) display, a three dimensional (3D) display, or other suitable display. Although the surface unit (112) is shown as separate from the E&P computer system (118) in FIG. 1.1, in other embodiments, the surface unit (112) and the E&P computer system (118) may be combined.

Although FIG. 1.1 shows a field (100) on the land, the field (100) may be an offshore field. In such a scenario, the subterranean formation (104) and structure(s) may be under the sea floor. Further, field data may be gathered from the field (100) that is an offshore field using a variety of offshore techniques.

FIG. 1.2 shows more details of the E&P computer system (118) in which one or more embodiments of machine-learning based drilling models for a new well may be implemented. In one or more embodiments, one or more of the modules and elements shown in FIG. 1.2 may be omitted, repeated, and/or substituted. Accordingly, embodiments of machine-learning based drilling models for a new well should not be considered limited to the specific arrangements of modules shown in FIG. 1.2.

As shown in FIG. 1.2, the E&P computer system (118) includes an E&P tool (230); a data repository (238) for storing input data, intermediate data, and resultant outputs of the E&P tool (230); and a field task engine (231) for performing various tasks of the field operation. In one or more embodiments, the data repository (238) may include one or more disk drive storage devices, one or more semiconductor storage devices, other suitable computer data storage devices, or combinations thereof. In one or more embodiments, content stored in the data repository (238) may be stored as a data file, a linked list, a data sequence, a database, a graphical representation, any other suitable data structure, or combinations thereof.

In one or more embodiments, the content stored in the data repository (238) includes a collection of existing well data sets (e.g., existing well data set A (233), existing well data set B (234-1), existing well data set C (234-2), etc.), a target well data set (235), a training data set (236), and a predicted ROP profile (237). In one or more embodiments, an existing well data set is a collection of data that describes or otherwise is associated with an existing well.

As used herein, the term “existing well” refers to a well that is already drilled, such as that corresponding to the wellsite A (114-1), wellsite B (114-2), wellsite C (114-3), etc. as depicted in FIG. 1.1. For example, the existing well data set A (233), existing well data set B (234-1), and existing well data set C (234-2) may correspond to the wellsite A (114-1), wellsite B (114-2), and wellsite C (114-3), respectively, as depicted in FIG. 1.1. Further, each of the existing well data set A (233), existing well data set B (234-1), and existing well data set C (234-2) may include one or more of well data (e.g., well data A (233-1)), drilling parameters (e.g., drilling parameter A (233-2)), bit parameters (e.g., bit parameter A (233-3)), well logs (e.g., well log A (233-4)), drilling fluid parameters (e.g., drilling fluid parameter A (233-5)), lithology parameters (e.g., lithology parameter A (233-6)), etc. An example of the existing well data set A (233), existing well data set B (234-1), or existing well data set B (234-2) is described in TABLE 1 below. Each entry in TABLE 1 is referred to as a property of the existing well.

TABLE 1
WELL DATA

| | |
|---|---|
| 1. | Well name |
| 2. | Trajectory |
| 3. | Location |

DRILLING PARAMETERS

| | |
|---|---|
| 1. | Hole depth |
| 2. | Rate of penetration (ROP) |
| 3. | Mud weight |
| 4. | Revolutions per minute |
| 5. | Hook load |
| 6. | Flow rate |
| 7. | Stand pipe pressure |
| 8. | Mud viscosity |
| 9. | Torque |
| 10. | Equivalent circulating density (ECD) |
| 11. | Temperature |

BIT PARAMETERS

| | |
|---|---|
| 1. | Bit type |
| 2. | Bit size (diameter) |
| 3. | Bit model |
| 4. | Total Flow Area (TFA) |
| 5. | Run number |
| 6. | Start depth |
| 7. | End depth |
| 8. | Drill length |
| 9. | Start date |
| 10. | Pulled out of hole date |
| 11. | Reason pulled out of hole |
| 12. | ROP |
| 13. | Dull grading |

WELL LOGS

| | |
|---|---|
| 1. | Gamma Ray |
| 2. | Spontaneous potential |

DRILLING FLUID PARAMETERS

| | |
|---|---|
| 1. | Density |
| 2. | Viscosity |
| 3. | Yield point |

LITHOLOGY PARAMETERS

| | |
|---|---|
| 1. | Formation name |
| 2. | Formation description |
| 3. | Start depth |
| 4. | End depth |
| 5. | Pressure gradient |
| 6. | Rock drillability |

In one or more embodiments, a training data set is a collection of data that is used to train a machine learning model based on machine learning algorithms. In one or more embodiments, the training data set (236) includes a subset of the existing well data sets that is selected based on a similarity with respect to the target well data set (235). In particular, the training data set (236) includes an analog well data set A (236-1), an analog well data set B (236-2), etc. For example, the analog well data set A (236-1) and analog well data set B (236-2) may correspond to the existing well data set A (233) and existing well data set B (233-1), respectively, while the existing well data set C (234-2) may be excluded from the training data set (236). More particularly, an analog well data set is a data set defined for an analog well. An analog well is an existing well that satisfies a similarity criterion with respect to a target well. In one or more embodiments, the similarity criterion defines, for at least a subset of the properties, a maximum difference between the values of one or more properties of the target well and the existing well in order for the existing well to be deemed an analog well. For example, the similarity criterion may include a multi-dimensional probability distribution function for multiple properties having continuous data. In one or more embodiments, the training data set (236) includes a ROP profile for each of the analog well data sets (e.g., analog well data set A (236-1), analog well data set B (236-2), etc.) included in the training data set (236).

In one or more embodiments, the target well data set (235) is a collection of data that describes or is otherwise associated with a target well. As used herein, the term “target well” refers to a new well not yet drilled that is planned to be drilled. For example, the target well data set (235) may include one or more of target well data (235-1), target lithology parameter (235-2), etc. of the target well. An example of the target well data set (235) is described in TABLE 2 below. Each entry in TABLE 2 is referred to as a property of the target well. For example, one or more properties of the target well may be estimated by the driller, and/or provided based on recent information of another well that is estimated in real-time.

TABLE 2
WELL DATA

| | |
|---|---|
| 1. | Well name |
| 2. | Trajectory |
| 3. | Location |

LITHOLOGY PARAMETERS

| | |
|---|---|
| 1. | Formation name |
| 2. | Formation description |
| 3. | Start depth |
| 4. | End depth |
| 5. | Pressure gradient |
| 6. | Rock drillability |

In one or more embodiments, the predicted ROP profile (237) is a prediction of one or more ROPs of the target well. As used herein, the term “ROP profile” refers to a collection of ROPs at different locations along a well. In other words, the ROP is the rate of penetration at a measured depth interval along the length of the well. Because the lithology and/or other operational characteristics of the subsurface changes, different measured depth intervals may have different ROPs that are efficient and productive for the measured depth interval. The ROP profile is the combination of ROPs for a well (e.g., target well, existing well, analog well, etc.) across multiple measured depth intervals.

In one or more embodiments, the E&P tool (230) includes an input receiver (221), a well analyzer (222), a drilling model generator (223), and a modeling engine (225). Each of these components of the E&P tool (230) is described below.

In one or more embodiments, the input receiver (221) is configured to obtain the existing well data sets (e.g., existing well data set A (233), existing well data set B (234-1), existing well data set C (234-2), etc.) and the target well data set (235) for analysis by the well analyzer (222) and the modeling engine (225). In one or more embodiments, the input receiver (221) obtains the existing well data sets (e.g., existing well data set A (233), existing well data set B (234-1), existing well data set C (234-2), etc.) and the target well data set (235), at least in part, from the surface unit (112) depicted in FIG. 1.1. For example, the input receiver (221) may obtain one or more portions of the existing well data sets (e.g., existing well data set A (233), existing well data set B (234-1), existing well data set C (234-2), etc.) and the target well data set (235) from the surface unit (112) intermittently, periodically, in response to a user activation, or as triggered by an event. In one or more embodiments, the input receiver (221) obtains the target well data set (235) prior to drilling the corresponding target well. In one or more embodiments, the input receiver (221) updates the target well data set (235) during drilling of the corresponding target well to generate an updated target well data set. For example, the target lithology parameters (235-2) may be updated during drilling of the target well.

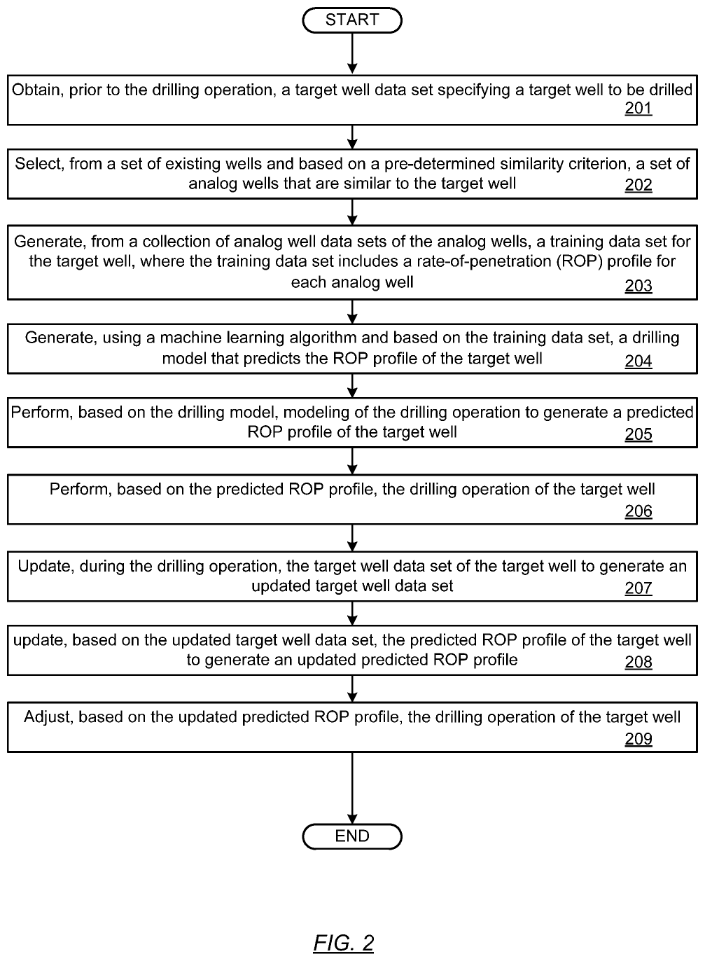

Accordingly, the intermediate and final results of the well analyzer (222) and the modeling engine (225) may be generated intermittently, periodically, prior to or during drilling the target well, in response to a user activation, or as triggered by an event. In one or more embodiments, the input receiver (221) obtains the existing well data sets (e.g., existing well data set A (233), existing well data set B (234-1), existing well data set C (234-2), etc.) and the target well data set (235) using the method described in reference to FIG. 2 below.

In one or more embodiments, the well analyzer (222) is automatically (or manually) configured to select, from the set of existing well data sets (e.g., existing well data set A (233), existing well data set B (234-1), existing well data set C (234-2), etc.) and based on a pre-determined similarity criterion, a set of analog well data sets (e.g., analog well data set A (236-1), analog well data set B (236-2), etc.) to form the training data set (236). In other words, the well analyzer (222) selects, from a set of existing wells (e.g., wellsite A (114-1), wellsite B (114-2), wellsite C (114-3), etc. depicted in FIG. 1.1), a set of analog wells (e.g., wellsite A (114-1) and wellsite B (114-2)) that is similar to the target well. For example, the well analyzer (222) may determine that the wellsite C (114-3) does not meet the pre-determined similarity criterion with respect to the target well and therefore may exclude the existing well data set C (234-2) from the training data set (236). In one or more embodiments, the well analyzer (222) generates the training data set (236) using the method described in reference to FIG. 2 below.

In one or more embodiments, the drilling model generator (223) is configured to generate, using a machine-learning algorithm and based on the training data set (236), the drilling model (224) that predicts the ROP profile of the target well. That is, the drilling model generator (223) generates the predicted ROP profile (237) based on the training data set (236). In one or more embodiments, the drilling model (224) describes a statistical relationship between the well data, the drilling parameters, the bit parameters, the well logs, the drilling fluid parameters, and the lithology parameters of the analog well data sets (e.g., analog well data set A (236-1), analog well data set B (236-2), etc.) in the training data set (236). In particular, the training data set (236) is used to validate results and model accuracy of the statistical relationship. In one or more embodiments, the drilling model (224) is used to generate the predicted ROP profile (237) by applying the statistical relationship based on the target well data (235-1) and the target lithology parameter (235-2) of the target well. In one or more embodiments, the drilling model generator (223) generates the drilling model (224) using the method described in reference to FIG. 2 below.

Because of the inability and/or infeasibility of sensors to gather data representing each location of the subterranean formation, complete knowledge of the subterranean formation is generally not available. Accordingly, the drilling model (224) is an approximation based at least in part on the sensor data. The greater the accuracy of the drilling model (224), the more efficient and productive the drilling and other field operations for gathering hydrocarbons and other valuable assets from the subterranean formation may be. One or more embodiments improve the accuracy of the drilling model (224), and thereby improve the field operations performed. In other words, because embodiments perform drilling operations based on a more accurate drilling model, one or more embodiments improve the efficiency and productivity of the drilling operations.

In one or more embodiments, the modeling engine (225) is configured to perform drilling modeling of the target well based, at least in part, on the drilling model (224) and the target well data set (235). In one or more embodiments, the drilling modeling includes generating the predicted ROP profile (237) of the target well. In one or more embodiments, the modeling engine (225) performs drilling modeling prior to drilling the target well. In one or more embodiments, the modeling engine (225) continues to perform drilling modeling during drilling of the target well. For example, the modeling engine (225) may update the predicted ROP profile (237) based on the updated target well data set received during drilling of the target well.

In one or more embodiments, the modeling engine (225) includes an inference engine, which is an artificial intelligence (AI) tool. For example, an inference engine, with a knowledge base such as the training data set (236), may form an expert system. In an expert system, the knowledge base stores facts and the inference engine applies logical rules to the knowledge base to deduce new knowledge. This process may iterate as each new fact in the knowledge base triggers additional rules in the inference engine.

In one or more embodiments, the modeling engine (225) performs the drilling modeling using the method described in reference to FIG. 2 below.

In one or more embodiments, the input data, intermediate data, and resultant outputs of the E&P tool (230) may be displayed to a user using a two dimensional (2D) display, a three dimensional (3D) display, or other suitable display. In one or more embodiments, the E&P computer system (118) includes the field task engine (231), which is configured to generate a field operation control signal based at least on a result generated by the E&P tool (230). For example, the field operation control signal may be based on the predicted ROP profile (237). As noted above, the field operation equipment depicted in FIG. 1.1 may be controlled by the field operation control signal. For example, the field operation control signal may be used to control an actuator, a fluid valve, or other electrical and/or mechanical devices disposed about the field (100) depicted in FIG. 1.1. In particular, the field operation control signal may be used to control the drilling equipment of the target well. In one or more embodiments, during drilling of the target well, the field task engine (231) may adjust the field control signal in response to the modeling engine (225) updating the predicted ROP profile (237) as described above.

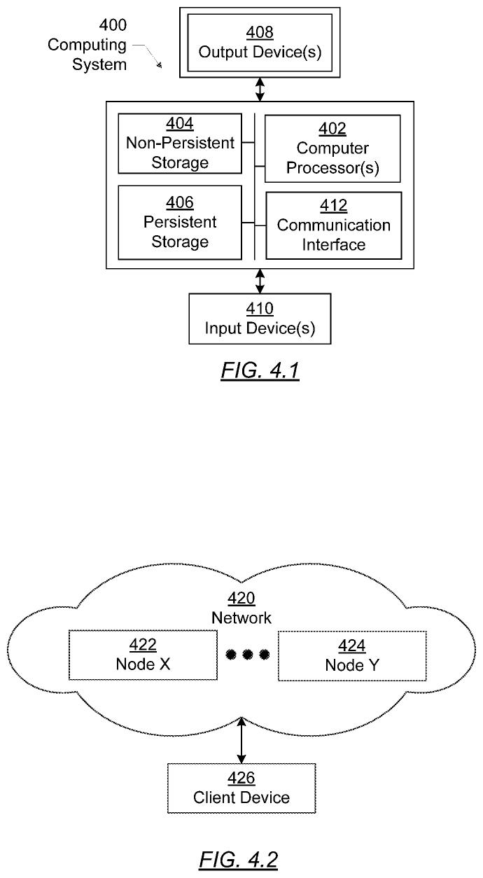

The E&P computer system (118) may include one or more system computers, such as those shown in FIGS. 4.1 and 4.2, which may be implemented as a server or any conventional computing system. However, those skilled in the art, having benefit of this disclosure, will appreciate that implementations of various technologies described herein may be practiced in other computer system configurations, including hypertext transfer protocol (HTTP) servers, hand-held devices, multiprocessor systems, microprocessor-based or programmable consumer electronics, network personal computers, minicomputers, mainframe computers, and the like.

While specific components are depicted and/or described for use in the units and/or modules of the E&P computer system (118) and the E&P tool (230), a variety of components with various functions may be used to provide the formatting, processing, utility, and coordination functions for the E&P computer system (118) and the E&P tool (230). The components may have combined functionalities and may be implemented as software, hardware, firmware, or combinations thereof.

FIG. 2 depicts an example method in accordance with one or more embodiments. For example, the method depicted in FIG. 2 may be practiced using the E&P computer system (118) of FIGS. 1.1 and 1.2, as described above. In one or more embodiments, one or more of the elements shown in FIG. 2 may be omitted, repeated, and/or performed in a different order. Accordingly, embodiments of machine-learning based drilling models for a new well should not be considered limited to the specific arrangements of elements shown in FIG. 2.

In particular, FIG. 2 shows an example flow chart to generate a set of compartments based on an initial set of surface segments within a volume of interest. Initially in Block 201, a target well data set is obtained that specifies a target well to be drilled. In one or more embodiments, the target well data set is obtained prior to the drilling operation. For example, the target well data set may be obtained by gathering raw measurement data from seismic sensors and/or sensors of existing wells used in surveying operations. The raw measurement data may be processed to obtain processed measurement data. The raw measurement data and/or the processed measurement data may form the target well data set. In some scenarios, before the drilling operation takes place, there will not be any sensor data for the target well. The target well data set may include planned data and lithology applicable for a wider area.

In Block 202, a set of analog wells that are similar to the target well is selected from a set of existing wells based on a pre-determined similarity criterion. In one or more embodiments, information is obtained from one or more of daily drilling reports, surface and downhole sensors, geological models, mud rheology, mud logging, survey data, etc. of an existing well to form a corresponding existing well data set. For example, the existing well data set may include at least the existing well data and existing well lithology parameters. Accordingly, the existing well is selected as an analog well if the corresponding existing well data set is determined as similar to the target well data set based on the pre-determined criterion.

For example, the existing well data and existing well lithology parameters are compared to the target well data and target lithology parameters according to the similarity criterion. In other words, the well names, trajectories, and locations may be compared between the existing well and the target well to generate a well data similarity measure. The comparison may determine a name difference of the well names (e.g., well names of certain wells may share a common portion or root), a geometry (shape and depth) difference of the trajectories, and/or a distance between the locations. Further, the name difference, the geometry difference, and the distance between the locations may be normalized with respective normalization factors. The normalized name difference, the normalized geometry difference, and the normalized distance between locations may be combined into a normalized sum as the well data similarity measure.

Similarly, the formation names, formation descriptions, start depths, end depths, pressure gradients, and rock drillabilities are compared between the existing well and the target well to generate a lithology similarity measure. For example, the differences in the formation names, formation descriptions, start depths, end depths, pressure gradients, and rock drillabilities may be normalized with respective normalization factors. The normalized differences may be combined into a normalized sum as the lithology similarity measure. In one or more embodiments, the existing well and the target well are determined to be similar if the well data similarity measure and/or the lithology similarity measure are within predefined limit.

In one or more embodiments, existing wells may be further identified based on user inputs for automatic selection of analog wells. In other words, a subset of the existing wells may be automatically selected as described above to form the set of analog wells. In other embodiments, the set of analog wells may be generated based on users manually determining that the subset of the existing wells is similar to the target well.

In Block 203, a training data set for the target well is generated from a collection of analog well data sets of the analog wells. In one or more embodiments, the training data set is a union of the analog well data sets. For example, the training data set may include the ROP profile for each of the analog wells.

In Block 204, a drilling model that predicts the ROP profile of the target well is generated using a machine learning algorithm based on the training data set. In one or more embodiments, an ensemble method using tree-based weak-learners (e.g., Random-Forest, Least-Squares Boosting, etc.) is used as the machine-learning algorithm to generate the drilling model.

In Block 205, modeling of the drilling operation is performed based on the drilling model to generate a predicted ROP profile of the target well. In one or more embodiments, the predicted ROP profile of the target well is generated from the target well data set by applying the statistical relationship, in the drilling model, between the well data, the drilling parameter, the bit parameter, the well log, the drilling fluid parameter, and the lithology parameter.

In Block 206, the drilling operation of the target well is performed based on the predicted ROP profile. In one or more embodiments, a control signal is generated based on the predicted ROP profile and applied to the drilling equipment of the target well. Accordingly, the drilling operation is performed based on the control signal.

In Block 207, during the drilling operation, the target well data set of the target well is updated to generate an updated target well data set. In one or more embodiments, the lithology parameters of the target well are updated using logging-while-drilling techniques to generate the updated target well data set during drilling of the target well.

In Block 208, the predicted ROP profile of the target well is updated based on the updated target well data set to generate an updated predicted ROP profile. For example, the ROP corresponding to one or more depths in the undrilled portion of the target well may be adjusted in the predicted ROP profile to generate the updated predicted ROP profile.

In Block 209, the drilling operation of the target well is adjusted based on the updated predicted ROP profile. In one or more embodiments, the aforementioned control signal is adjusted based on the updated predicted ROP profile. Accordingly, the drilling operation is adjusted in response to adjusting the control signal.

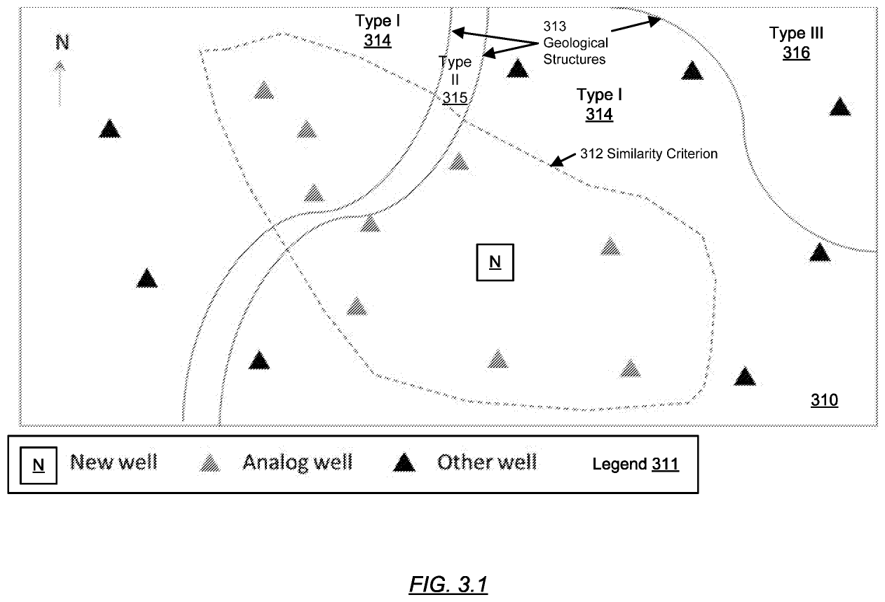

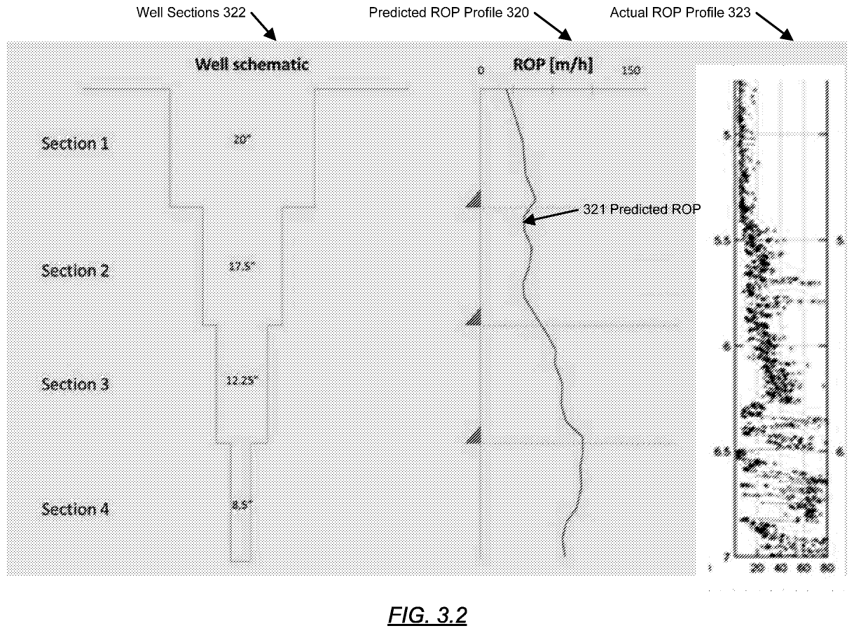

FIGS. 3.1 and 3.2 show examples in accordance with one or more embodiments. In one or more embodiments, the examples shown in these figures may be practiced using the E&P computer system shown in FIGS. 1.1 and 1.2 and the method described above with reference to FIG. 2. The following examples are not intended to limit the scope of the claims.

As shown in FIGS. 3.1 and 3.2, a machine-learning based approach is used to concurrently capture and characterize various facets of drilling dynamics using multiple sources of field data. Specifically, a machine-learning based drilling model is used to predict the ROP for new wells using analog well data. Such an application may be used for well-planning purposes. During the well planning, a well planner user may input various drilling control parameters into the drilling model to obtain an estimate of a ROP profile representing a predicted drilling time for various well sections, and other related quantities of interest. Prior to drilling a new well, ROP profile predictions may provide a more accurate estimate of the resources to be used for drilling, drilling time, and the associated costs. Hence, a more informed and reasoned technique for well-planning may be realized. In turn, this provides a starting point for additional resource optimization.

FIG. 3.1 shows a top view diagram (310) of analog wells that are selected, from a set of existing wells, as similar to a new well to be drilled. The new well, analog wells, and existing wells are represented by icons defined in the legend (311). This selection may be fully-automated or user-specified. In the diagram (310), the geological structures (313) are shown across the field, such as the field (100) depicted in FIG. 1.1 above. The geological structures (313) may separate different formation types, such as type I (314), type II (315), and type III (316). In the example shown in FIG. 3.1, the analog wells are selected based on the similarity criterion (312) that is a combination of distance from the new well, similarity in well geometries, and similarity in the formation types (e.g., based on lithology parameters) with respect to the new well. Once the analog wells are selected, a collection of analog well data sets is obtained from multiple sources having different measurement types. Such sources include daily drilling reports, surface and downhole sensors, geological models, mud rheology, mud logging, and survey data of the selected analog wells. Data in the analog well data sets may be in different formats (i.e., measurement types) that are manipulated, transformed, or otherwise normalized for calculation purposes. An example analog well data set for an analog well shown in the top view diagram (310) may include a well location, wellbore trajectory, ROP profile, fracture gradient, etc. of the analog well and a mud weight, rotation-per-minute, hook load, stand pipe pressure, bit type, etc. used during drilling of the analog well.

After gathering the relevant data for the analog well data set, next, the data is prepared and a ROP prediction model for the new well is trained based on machine-learning methods using tree-based weak-learners, such as Random-Forest and Least-Squares Boosting. During the machine-learning process, the measurement types are analyzed concurrently to discover and establish complex multi-dimensional relationships between the analyzed data in different measurement types. For example, analyzed data in different measurement types may be used as continuous variables and/or as categorical variables, which are either inherently categorized or categorized through the process of discretization, during the machine-learning process. Quantities derived from raw measurement types are used in the machine-learning process via different levels of mathematical transformations, combinations of raw variables, use of sequential structures to make transparent higher-order correlative relationships, the use of time- and frequency-domain summaries, or any combination of these. Some of these combinations are designed to capture, either local or global, drilling dynamical regimes (e.g., vibrations, skin friction, etc.), while others are derived through empirical studies of variable importance.

FIG. 3.2 shows an example of a predicted ROP profile (320), including a predicted ROP (321) for different depths in the well sections (322), compared to an example of an actual ROP profile (323). As described above, the predicted ROP profile (320) is used by the well planner to estimate the time to drill the different well sections. The predicted ROP profile (320) may also be used to support the downhole equipment selection process depending on the desired ROP for each well section. After the drilling is complete for the new well, the actual ROPs used during drilling for different depths are compiled into the actual ROP profile (323).

Embodiments of machine-learning based drilling models for a new well may be implemented on a computing system. Any combination of mobile, desktop, server, router, switch, embedded device, or other types of hardware may be used. For example, as shown in FIG. 4.1, the computing system (400) may include one or more computer processors (402) (e.g., central processing unit, graphics processing unit, etc. that are located locally or in the Internet-based computing cloud), non-persistent storage (404) (e.g., volatile memory, such as random access memory (RAM), cache memory, etc.), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), and numerous other elements and functionalities.

The computer processor(s) (402) may be an integrated circuit for processing instructions. For example, the computer processor(s) may be one or more cores or micro-cores of a processor. The computing system (400) may also include one or more input devices (410), such as a touchscreen, keyboard, mouse, microphone, touchpad, electronic pen, or any other type of input device.

The communication interface (412) may include an integrated circuit for connecting the computing system (400) to a network (not shown) (e.g., a local area network (LAN), a wide area network (WAN) such as the Internet, mobile network, or any other type of network) and/or to another device, such as another computing device.

Further, the computing system (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing systems exist, and the aforementioned input and output device(s) may take other forms.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by one or more processors, is configured to perform one or more embodiments.

The computing system (400) in FIG. 4.1 may be connected to or be a part of a network. For example, as shown in FIG. 4.2, the network (420) may include multiple nodes (e.g., node X (422), node Y (424)). Each node may correspond to a computing system, such as the computing system shown in FIG. 4.1, or a combined group of nodes may correspond to the computing system shown in FIG. 4.1. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (400) may be located at a remote location and connected to the other elements over a network.

Although not shown in FIG. 4.2, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (422), node Y (424)) in the network (420) may be configured to provide services for a client device (426). For example, the nodes may be part of a cloud computing system. The nodes may include functionality to receive requests from the client device (426) and transmit responses to the client device (426). The client device (426) may be a computing system, such as the computing system shown in FIG. 4.1. Further, the client device (426) may include and/or perform at least a portion of one or more embodiments.

The computing system or group of computing systems described in FIGS. 4.1 and 4.2 may include functionality to perform a variety of operations disclosed herein. For example, the computing system(s) may perform communication between processes on the same or a different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, or a memory-mapped file. Further details pertaining to some of these non-limiting examples are provided below.

Based on the client-server networking model, sockets may serve as interfaces or communication channel end-points that enable bidirectional data transfer between processes on the same device. First, in accordance with the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process generates a reply, which includes at least the requested data, and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. After creation, the initializing process then mounts the shareable segment, subsequently mapping the shareable segment into the address space associated with the initializing process. Following the mounting, the initializing process proceeds to identify and grant access to one or more authorized processes that may also write and read data to and from the shareable segment. Changes made to the data in the shareable segment by one process may immediately affect other processes that are also linked to the shareable segment. Further, when one of the authorized processes accesses the shareable segment, the shareable segment maps to the address space of that authorized process. Often, one authorized process, other than the initializing process, may mount the shareable segment at any given time.

Other techniques may be used to share data, such as the various data described herein, between processes without departing from the scope of this disclosure. The processes may be part of the same or a different application and may execute on the same or a different computing system.

Rather than or in addition to sharing data between processes, the computing system performing one or more embodiments may include functionality to receive data from a user. For example, in one or more embodiments, a user may submit data via a graphical user interface (GUI) on the user device. Data may be submitted via the GUI by a user selecting one or more GUI widgets or inserting text and other data into GUI widgets using a touchpad, a keyboard, a mouse, or any other input device. In response to selecting a particular item, information regarding the particular item may be obtained from persistent or non-persistent storage by the computer processor. Upon selection of the particular item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments, may extract one or more data items from the obtained data. For example, the extraction may be performed as follows by the computing system in FIG. 4.1. First, the organizing pattern (e.g., grammar, schema, layout, etc.) of the data is determined, which may be based on one or more of the following: position (e.g., bit or column position, Nth token in a data stream, etc.), an attribute associated with one or more values, or a hierarchical/tree structure, which consists of layers of nodes at different levels of detail (e.g., in nested packet headers or nested document sections). Then, the raw, unprocessed stream of data symbols is parsed, in the context of the organizing pattern, into a stream (or layered structure) of tokens, where each token may have an associated token “type”.

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string. The extraction criteria may be a query presented to a structured data repository, which may be organized according to a database schema or data format, such as XML.

The extracted data may be used for further processing by the computing system. For example, the computing system of FIG. 4.1, while performing one or more embodiments, may perform data comparison. Data comparison may be used to compare two or more data values (e.g., A, B). For example, one or more embodiments may determine whether A>B, A=B, A !=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments, A and B may be vectors, and comparing A with B includes comparing the first element of vector A with the first element of vector B, comparing the second element of vector A with the second element of vector B, etc. In one or more embodiments, if A and B are strings, the binary values of the strings may be compared.

The computing system in FIG. 4.1 may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, an update statement, a create statement, a delete statement, etc. Moreover, the statement may include parameters that specify data or a data container (e.g., database, table, record, column, view, etc.), conditions (e.g., comparison operators), or functions (e.g., join, full join, count, average, etc.), or others. The DBMS may execute the statement. For example, the DBMS may access a memory buffer, access a reference, or index a file for reading, writing, deletion, in any combination, for responding to the statement. The DBMS may load the data from persistent or non-persistent storage and perform computations to respond to the query. The DBMS may return the result(s) to the user or software application.

The computing system of FIG. 4.1 may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user (e.g., data presented as actual data values through text), or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description presents a few examples of functions performed by the computing system of FIG. 4.1 and the nodes and/or client device in FIG. 4.2. Other functions may be performed using one or more embodiments.

The systems and methods provided relate to the acquisition of hydrocarbons from an oilfield. It will be appreciated that the same systems and methods may be used for performing subsurface operations, such as mining, water retrieval, and acquisition of other underground fluids or other geomaterials from other fields. Further, portions of the systems and methods may be implemented as software, hardware, firmware, or combinations thereof.

While one or more embodiments have been described with respect to a limited number of embodiments, those skilled in the art, having benefit of this disclosure, will appreciate that other embodiments may be devised which do not depart from the scope as disclosed herein. Accordingly, the scope should be limited by the attached claims.

1. A method for performing a drilling operation in a subterranean formation of a field, comprising:
obtaining, prior to the drilling operation, a target well data set specifying a target well to be drilled;
selecting, from a plurality of existing wells, a plurality of analog wells that satisfy a pre-determined similarity criterion with respect to the target well;
generating, from a plurality of analog well data sets of the plurality of analog wells, a training data set for the target well, wherein the training data set comprises a rate-of-penetration (ROP) profile for each of the plurality of analog wells;
generating, using a machine-learning algorithm and based on the training data set, a drilling model that predicts the ROP profile of the target well; and
performing, based on the drilling model, modeling of the drilling operation to generate a predicted ROP profile of the target well.

2. The method of claim 1, wherein each of the plurality of analog well data sets comprises a collection of well data, a drilling parameter, a bit parameter, a well log, a drilling fluid parameter, and a lithology parameter of at least one of the plurality of analog wells.

3. The method of claim 2, wherein the target well data set comprises a collection of well data and a lithology parameter of the target well.

4. The method of claim 3, wherein the drilling model comprises a statistical relationship between the well data, the drilling parameter, the bit parameter, the well log, the drilling fluid parameter, and the lithology parameter of the at least one of the plurality of analog wells.

5. The method of claim 4, wherein the drilling parameter comprises the ROP profile for the at least one of the plurality of analog wells.

6. The method of claim 1, further comprising:
performing, based on the predicted ROP profile, the drilling operation of the target well.

7. The method of claim 6, further comprising:
updating, during the drilling operation, the target well data set of the target well to generate an updated target well data set;
updating, based on the updated target well data set, the predicted ROP profile of the target well to generate an updated predicted ROP profile; and
adjusting, based on the updated predicted ROP profile, the drilling operation of the target well.

8. A system for performing a drilling operation in a subterranean formation of a field, comprising:
an exploration and production (E&P) computer system, comprising:
a computer processor;
a memory that stores instructions executed by the computer processor, wherein the instructions comprise functionality to:
obtain, prior to the drilling operation, a target well data set specifying a target well to be drilled;
select, from a plurality of existing wells, a plurality of analog wells that satisfy a pre-determined similarity criterion with respect to the target well;
generate, from a plurality of analog well data sets of the plurality of analog wells, a training data set for the target well, wherein the training data set comprises a rate-of-penetration (ROP) profile for each of the plurality of analog wells;
generate, using a machine-learning algorithm and based on the training data set, a drilling model that predicts the ROP profile of the target well; and
perform, based on the drilling model, modeling of the drilling operation to generate a predicted ROP profile of the target well; and
a repository that stores the training data set, the drilling model, and the predicted ROP profile of the target well.

9. The system of claim 8, wherein each of the plurality of analog well data sets comprises a collection of well data, a drilling parameter, a bit parameter, a well log, a drilling fluid parameter, and a lithology parameter of at least one of the plurality of analog wells.

10. The system of claim 9, wherein the target well data set comprises a collection of well data and a lithology parameter of the target well.

11. The system of claim 10, wherein the drilling model comprises a statistical relationship between the well data, the drilling parameter, the bit parameter, the well log, the drilling fluid parameter, and the lithology parameter of the at least one of the plurality of analog wells.

12. The system of claim 11, wherein the drilling parameter comprises the ROP profile for the at least one of the plurality of analog wells.

13. The system of claim 8, the instructions further comprising functionality to:
generate a control signal based on the predicted ROP profile of the target well, and wherein the system further comprises a drilling equipment coupled to the E&P computer system and configured to:
perform the drilling operation of the target well based on the control signal.

14. The system of claim 13, the instructions further comprising functionality to:
update, during the drilling operation, the target well data set of the target well to generate an updated target well data set;
update, based on the updated target well data set, the predicted ROP profile of the target well to generate an updated predicted ROP profile; and
adjusting, based on the updated predicted ROP profile, the drilling operation of the target well.

15. (canceled)
